(19) United States
(12) Patent Application Publication
(10) Pub. No.: US 2015/0058158 A1
(43) Pub. Date: Feb. 26, 2015

(54) Coordinated Purchasing

(71) Applicant: Irene Yen, San Jose, CA (US)

(72) Inventor: Irene Yen, San Jose, CA (US)

(21) Appl. No.: 13/973,617

(22) Filed: Aug. 22, 2013

(51) Int. Cl. G06Q 30/06

(52) U.S. Cl. CPC G06Q 30/0631
USPC 705/26.7

(57) ABSTRACT

Methods and systems are provided for coordinating purchases. For example, account information for a user can be stored in one or more memories. The account information can include an identification of a first product, such as a first product being purchased by the user. A communication can be received via one or more hardware processors in communication with the one or more memories. The communication can include an identification of a second product. The account information can be accessed via one or more hardware processors. Whether or not the second product is related to the first product can be determined via the one or more hardware processors. The second product can be coordinated, via one or more hardware processors, with respect to the first product if the second product is related to the first product.

### BACKGROUND

1. Technical Field

The present disclosure generally relates to electronic commerce and, more particularly, relates to methods and systems for coordinating purchases, such as purchases of related products made online.

2. Related Art

The purchasing of products online has become very popular. Generally, an online seller for a desired product can be found quickly. Reviews of the product and seller are often readily available. The product can typically be shipped so as to arrive at a purchaser's home or office in just a few days. Product and shipping prices can be reasonable. Various payment methods are usually offered.

Locating a product can be as simple as typing the product name into an online search engine or searching an online seller, such as eBay. For example, a purchaser can go to the eBay website and simply type the name of the desired product into a box provided near the top of the webpage. The purchaser will then be shown listings from the sellers who offer the product. The purchaser can read reviews of the product on many merchant's websites.

If the purchaser is satisfied with the product, the purchaser can select the product and proceed to checkout. During checkout, the purchaser can determine how payment for the product is to be made and can select the shipping method. For example, the purchaser can select to pay for the product using PayPal and can specify to have the product shipped in two days. The purchaser can then be presented with the total price, the payment method, and the shipping terms prior to approving the purchase.

In this manner, the purchaser can easily have the product delivered to the purchaser's home or office. The purchaser does not have to leave the home or office to make the purchase or receive the product. The purchase often costs less than or about the same as a purchase of the same product from a traditional brick and mortar store. Such convenience makes online purchasing a very attractive alternative to conventional brick and mortar store shopping.

### BRIEF DESCRIPTION OF THE DRAWINGS

The included drawings are for illustrative purposes and serve only to provide examples of possible systems and methods for the disclosed coordinated purchasing. These drawings in no way limit any changes in form and detail that may be made to that which is disclosed by one skilled in the art without departing from the spirit and scope of this disclosure.

FIG. 1 is a in block diagram of a computing system that is adapted for implementing one or more examples of processes involving activities with respect to coordinated purchasing, according to an embodiment.

FIG. 2 is a block diagram of an example of a computer system suitable for implementing on one or more devices of the computing system in FIG. 1, according to an embodiment.

FIG. 3 is a block diagram of a system for coordinated purchasing, according to an embodiment.

FIG. 4 is a flow chart of a method for coordinated purchasing, according to an embodiment.

### DETAILED DESCRIPTION

Although online shopping is a very attractive alternative to conventional brick and mortar store shopping, there are aspects of online shopping that tend to detract from its overall utility and desirability. For example, products that are to be used together can arrive at different times, thus requiring the user to wait for the last such product to arrive before any of the products can be used. For example, a flashlight requiring specific batteries may not be usable until both the flashlight and the batteries arrive. Thus, the flashlight must be set aside and stored while awaiting the batteries.

Further, issues of compatibility can be more critical when shopping online. For example, if the flashlight arrives with incorrect batteries, then new correct batteries would need to be obtained. Often, the incorrect batteries must be returned. Returning the incorrect batteries and obtaining the new batteries online can be undesirably time consuming and inconvenient.

Methods and systems are provided for coordinating purchases. According to an embodiment, such methods and systems can better assure that products that are intended to be used together arrive more closely in time with respect to one another. According to an embodiment, such methods and systems can better assure that products that are intended to be used together are compatible with one another.

For example, products that are intended to be used together can be shipped in the same time frame. Coordinated shipping can be used to make such products arrive together or at substantially the same time. Coordinated shipping from different shippers or merchants can be provided. Shipping can be coordinated from different places and when using different shipping methods. Thus, different shipping times can be coordinated such that the products arrive at approximately the same time. For example, shipping times can be coordinated such that products arrive on the same day. As a further example, shipping times can be coordinated such that product arrive within one, two, three, four, or five days with respect to one another.

Inventory can be considered in providing coordination. For example, backordered or long pull items can be accounted for so that they are delivered to the user at the desired time. Thus, slow delivery products such as backordered or long pull products can be coordinated with products having faster delivery times such that all related products are delivered at about the same time.

If one product is not in inventory, then another, compatible product that is in inventory can be substituted for the product that is not in inventory. For example, if a flashlight and batteries are being purchased and the particular batteries being purchased are not in inventory, then other, compatible batteries that are in inventory can be substituted.

Coordination can include providing two or more products at desired times with respect to one another. The desired times can be substantially different from one another. Coordination can include having the products arrive at substantially the same time. Coordination can include having the products arrive in a desired sequence, e.g., one before the other. Coordination can include having one product arrive a predetermined amount of time before another product. For example, a consumable product can be timed to arrive just prior to a previously delivered consumable product being fully consumed.

In some instances, one or more products are needed by a specified date or the products are not needed at all. Such coordination can be used to assure that all such products are delivered by the desired date.

Coordination can include delivering products that work together with one another regardless of how or where the products are purchased. Thus, if a flashlight and batteries for the flashlight are purchased separately online (such as at different times and from different merchants), then a relationship between these products can be determined and the delivery of these products can be coordinated.

In this manner, distributed checkout can be better facilitated. That is, products can be checked out from a plurality of different online merchants and the products can be shipped or otherwise treated as though the products were purchased from a single merchant.

Products purchased can be matched for delivery, compatibility, or any other criteria. Examples of criteria for compatibility can include electrical characteristics, mechanical characteristics, size, weight, color, or any other characteristic. The user can specify and/or prioritize aspects of compatibility that are to be considered.

Products from one seller can be matched with products from another seller. For example, a flashlight can be purchased from one merchant and the batteries can be purchased from another merchant. Coordination can assure that the batteries are suitable for use with the flashlight and that the flashlight and batteries arrive at about the same time. Such coordination can be facilitated by one of the merchants, by a payment provider, by a shipper, by an app of the user (such as an app of a mobile device of the user), by a dedicated coordination service or server, and/or by any other device or system.

The coordinated purchase feature can go with the user. That is, the user can coordinate purchases wherever and whenever such purchases are made. For example, the coordination of purchases can be facilitated by a payment provider, such as PayPal, the benefits and features of which go with the user wherever and whenever the user makes purchases.

Coordination can insure capability across products. For example, coordination can assure that a shirt matches pants that were ordered with the shirt. Heuristics or artificial intelligence can be used to facilitate such matching. Purchase histories can be used to facilitate such matching. For example, if a particular color of shirt is never or very seldom purchased with a particular color of pants, then the user can be notified of the potential incompatibility when the user make such a purchase.

Exemplary applications of apparatuses and methods according to one or more embodiments are described in this section. These examples are being provided solely to add context and aid in the understanding of the embodiments. It will thus be apparent to one skilled in the art that the embodiments may be practiced without some or all of these specific details. In other instances, well known process steps have not been described in detail in order to avoid unnecessarily obscuring the disclosure. Other applications are possible, such that the following examples should not be taken as limiting.

In the following detailed description, references are made to the accompanying drawings, which form a part of the description and in which are shown, by way of illustration, various specific embodiments. Although these embodiments are described in sufficient detail to enable one skilled in the art to practice the embodiments, it is understood that these examples are not limiting, such that other embodiments may be used, and changes may be made without departing from the spirit and scope of the disclosure.

The disclosure relates, in the various described embodiments, to devices, systems and methods involving activities with respect to online, as well as brick and mortal store purchasing. In various particular embodiments, the systems or methods can involve one or more user devices in communication over a network. Such a network can facilitate a streamlined process involving coordinated purchasing.

While the various examples disclosed herein focus on coordinated purchasing, it will be understood that the various inventive principles and embodiments disclosed herein can be applied to other types of merchant transactions and arrangements as well. For example, purchases made in brick and mortar stores can be coordinated.

According to an embodiment, a system can comprise one or more memories storing account information for a user. The account information can include an identification of a first product, such as a first product being purchased by the user and/or such as a first product being shipped to the user.

One or more hardware processors can be in communication with the one or more memories. The one or more hardware processors can be operable to receive a communication including an identification of a second product. The communication can be received from the user. The communication can be received from another person. The communication can be received from a device, such as a mobile device, a computer, or a server.

The one or more hardware processors can be operable to access the account information, such as to identify the first product. Thus, the one or more hardware processors can determine what products the user has ordered, what products have already shipped, and what product will ship later, as well as when the later shipped products will ship.

The one or more hardware processors can be operable to determine if the second product is related to the first product. The second product can be related to the first product if the first product and the second product are used together. For example, a flashlight and batteries for the flashlight are used together. The second product can be related to the first product if the second product is commonly purchased along with the first product. Purchase histories can be used to determine what products are commonly purchased together.

For example, a flashlight and batteries for the flashlight are commonly purchased together. Any desired criteria can be used to determine if the second product is related to the first product. Any desired combination of criteria can be prioritize and used to determine if the second product is related to the first product.

The one or more hardware processors can be operable to coordinate the second product with respect to the first product, if the second product is related to the first product. Coordinating the second product with respect to the first product can comprise shipping the first product and/or the second product such that the second product arrives within substantially a predetermine amount of time with respect to arrival of the first product. Coordinating the second product with respect to the first product can comprise assuring that the second product is compatible with the first product.

Coordinating the second product with respect to the first product can comprise providing or delivering a second product that is compatible with the first product. Such compatibility can include anything than enhances usefulness and/or desirability of the combination of the first product and the second product.

Coordinating the second product with respect to the first product can comprise anything that considers the identity, features, components, aspects, or functions of one product or anything related to the product (such as shipping times, warranties, payment methods, etc.) as they relate to another product and/or anything that provides a result that is beneficial or desirable to the user.

The identification of the second product can be provided by the user. For example, the user can order the second product online. In response to the user ordering the second product, the system can send a communication to the user if the second product is not compatible with respect to the first product. The communication can regard compatibility of the second product with respect to the first product. For example, the communication can inform the user of any incompatibilities of the second product with respect to the first product or of any other concerns or useful information regarding the first product and the second product. Such information can include technical information and purchase incentives. Such incompatibilities can include anything that detracts from the usefulness and/or desirability of the combination of the first product and the second product. Thus, compatibility can include partial compatibility and incompatibility can include partial incompatibility.

The system can send a communication to the user and the communication can suggest an alternative to the second product, if the second product is not compatible with respect to the first product. For example, if the user orders the first product, e.g., a flashlight, and then orders the second product, e.g., batteries, then the system can determine if the batteries are compatible with the flashlight. If the batteries are not compatible with the flashlight, then the system can send a communication to the user to inform the user that the batteries are not compatible with the flashlight.

The system can proceed with the order if no response to the communication is received from the user. The system can cancel the battery order if the user requests such cancellation. Alternatively, the system can cancel the order if no response to the communication is received from the user.

The system can send a communication to the user and the communication can suggest a second product that is compatible with respect to the first product. For example, if the user ordered batteries that are incompatible with a flashlight, then compatible batteries can be suggested in the communication.

Compatibility can include price considerations. For example, if other, less expensive batteries are available for the flashlight, then the less expensive batteries can be substituted. Such substitution can either require the user's authorization or can not require the user's authorizations, as specified by the user such as during a set up procedure for the system.

The user's purchase history and/or the purchase history of others can be used, at least in part, to determine if the second order is related to the first order and/or if the second order is compatible with the first order. For example, if the user has a history of ordering particular batteries and then orders the same batteries along with a product with which the batteries are not compatible, then the system can infer that the batteries are to be used with another product (not the product ordered along with the batteries) and can consider the two orders unrelated.

As a further example, the system can infer that two products are sufficiently compatible, or at least are desired by the user, when the two products are ordered together if the two products have been ordered together by the same user or a different user in the past. Thus, two products that may otherwise be considered incompatible can be considered compatible due to a history of the two products being ordered together. A product relationships database can store and provide such information. Product histories maintained by the user, other users, social networking systems, merchants, credit card companies, payment providers, and/or any other entity can provide such information. In this manner, intelligence can be added to the decision making processes regarding product relationships and product compatibilities.

The system can send a communication to the user and the communication can suggest one or more additional products that are compatible with respect to the first product and/or the second product. For example, if the user ordered a flashlight and batteries, then the system can suggest filters for the flashlight and/or a charger for the batteries.

A seller of the first product can be the same as the seller of the second product. For example, the user can order both the first product and the second product from the same merchant on eBay. The seller of the first product can be different from the seller of the second product. For example, the user can order the first product and the second product from two different merchants on eBay or the user can order the first product from a merchant on eBay and can order the second from StubHub. In either instance, the system can determine if the second product is related to the first product and can coordinate the second product with respect to the first product if the second product is related to the first product. Thus, the users need not rely upon the seller to coordinate products. The different merchants need not be affiliated or related. For example, a payment provider system, such as PayPal, can determine whether two products from two unrelated merchants are compatible and the user can utilize the payment provider to make the purchase from both merchants, such that the payment provider knows the products purchased from each merchant.

The second product can be suggested to the user by the system. Thus, when the system determines that the user may want or need a second product after the user has ordered the first product, then the system can suggest to the user that the user order one or more second products.

The second product can be suggested to the user by the system a substantial length of time after the user has purchased the first product. For example, when a new product becomes available, the new product can be suggested to the user as the second product. In this manner, the user can be informed of products that were not available at the time of purchase of the first product, but which may be desirable.

In some instances, the system can simply add the second product to the order after the user has ordered the first product. In such instances, the second product can be included in the shipment of the first product. The user can specify when the second product can be automatically added to the shipment. For example, the user can specify that all compatible products under a predetermined dollar amount are to be automatically added to a shipment. As a further example, the user can specify that only batteries are to automatically be added to all orders for products that require, but do not include, batteries. The user can specify when the second product can be automatically added to the shipment, such as during a set up process for the system.

Determining if the second product is related to first product can comprise accessing a database of product relationships. For example, a payment server, an online seller server, a dedicated server, or any other device can contain product relationship information, such as a product relationship database, that facilitates the answering of inquiries regarding product relationships. For example, one product can be looked up in the database to determine what other product relate thereto.

According to an embodiment, account information for a user can be stored in one or more memories. The account information can include an identification of a first product, such as a first product being purchased by the user. A communication can be received via one or more hardware processors in communication with the one or more memories. The communication can include an identification of a second product. The account information can be accessed via one or more hardware processors. Whether or not the second product is related to the first product can be determined via the one or more hardware processors. The second product can be coordinated, via one or more hardware processors, with respect to the first product if the second product is related to the first product.

According to an embodiment, a computer program product can comprise a non-transitory computer readable medium. The non-transitory computer readable medium can have computer readable and executable code for instructing one or more processors to perform any of the methods disclosed herein.

The one or more memories and one or more hardware processors can be part of the same device, e.g., server. The one or more memories and one or more hardware processors can be part of different devices, e.g., servers. The one or more memories and one or more hardware processors can be co-located. The one or more memories and one or more hardware processors can be located in different places, e.g., different rooms, different buildings, different cities, or different states.

### Systems and Devices

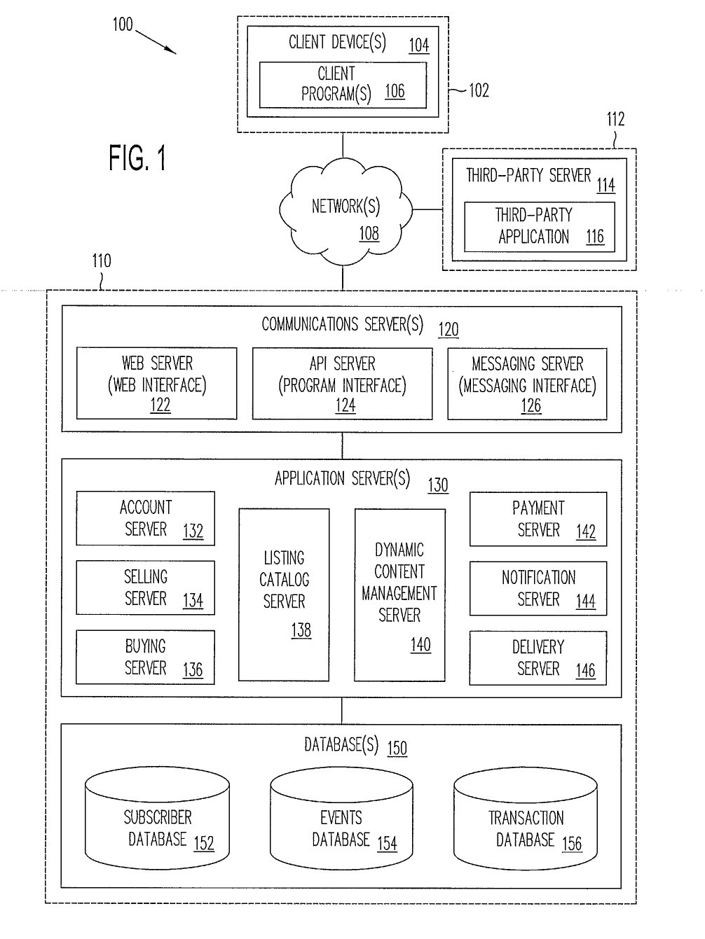

Referring now to FIG. 1, an exemplary embodiment of a computing system adapted for implementing one or more processes involving coordinated purchases is illustrated in block diagram format. As shown, computing system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

Computing system 100 can include, among various devices, servers, databases and other elements, a client 102 that may comprise or employ one or more client devices 104, such as a mobile computing device, a PC, and/or any other computing device having computing and/or communications capabilities in accordance with the described embodiments. Client devices 104 generally may provide one or more client programs 106, such as system programs and application programs to perform various computing and/or communications operations. Exemplary system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a web browser application, messaging applications (e.g., e-mail, IM, SMS, MMS, telephone, voicemail, VoIP, video messaging), contacts application, calendar application, electronic document application, database application, media application (e.g., music, video, television), location-based services (LBS) application (e.g., GPS, mapping, directions, point-of-interest, locator), and so forth. One or more of client programs 106 may display various graphical user interfaces (GUIs) to present information to and/or receive information from one or more of client devices 104.

As shown, client 102 can be communicatively coupled via one or more networks 108 to a network-based system 110. Network-based system 110 may be structured, arranged, and/or configured to allow client 102 to establish one or more communications sessions with network-based system 110 using various computing devices 104 and/or client programs 106. Accordingly, a communications session between client 102 and network-based system 110 may involve the unidirectional and/or bidirectional exchange of information and may occur over one or more types of networks 108 depending on the mode of communication. While the embodiment of FIG. 1 illustrates a computing system 100 deployed in a client-server operating environment, it is to be understood that other suitable operating environments and/or architectures may be used in accordance with the described embodiments.

Data and/or voice communications between client 102 and the network-based system 110 may be sent and received over one or more networks 108 such as the Internet, a WAN, a WWAN, a WLAN, a mobile telephone network, a landline telephone network, a VoIP network, as well as other suitable networks. For example, client 102 may communicate with network-based system 110 over the Internet or other suitable WAN by sending and or receiving information via interaction with a web site, e-mail, IM session, and/or video messaging session. Any of a wide variety of suitable communication types between client 102 and system 110 can take place, as will be readily appreciated.

In various embodiments, computing system 100 can include, among other elements, a third party 112, which may comprise or employ a third-party server 114 hosting a third-party application 116. In various implementations, third-party server 314 and/or third-party application 116 may host a web site associated with or employed by a third party 112. For example, third-party server 114 and/or third-party application 116 may enable network-based system 110 to provide client 102 with additional services and/or information, such as coordinated purchases. In some embodiments, one or more of client programs 106 may be used to access network-based system 110 via third party 112. For example, client 102 may use a web client to access and/or receive content from network-based system 110 after initially communicating with a third-party web site 112.

Network-based system 110 may comprise one or more communications servers 120 to provide suitable interfaces that enable communication using various modes of communication and/or via one or more networks 108. Communications servers 120 can include a web server 122, an API server 124, and/or a messaging server 126 to provide interfaces to one or more application servers 130. Application servers 130 of network-based system 110 may be structured, arranged, and/or configured to provide various coordinated purchase related services to users that access network-based system 110. In various embodiments, client 102 may communicate with applications servers 130 of network-based system 110 via one or more of a web interface provided by web server 122, a programmatic interface provided by API server 124, and/or a messaging interface provided by messaging server 126. It can be appreciated that web server 122, API server 124, and messaging server 126 may be structured, arranged, and/or configured to communicate with various types of client devices 104 and/or client programs 106 and may interoperate with each other in some implementations.

Web server 122 may be arranged to communicate with web clients and/or applications such as a web browser, web browser toolbar, desktop widget, mobile widget, web-based application, web-based interpreter, virtual machine, and so forth. API server 124 may be arranged to communicate with various client programs 106 and/or a third-party application 116 comprising an implementation of API for network-based system 110. Messaging server 126 may be arranged to communicate with various messaging clients and/or applications such as e-mail, IM, SMS, MMS, telephone, VoIP, video messaging, and so forth, and messaging server 126 may provide a messaging interface to enable access by client 102 and/or third party 112 to the various services and functions provided by application servers 130.

When implemented as a coordinated purchase system, application servers 130 of network-based system 110 may provide various online marketplace and payment services including, for example, account services, buying services, selling services, listing catalog services, dynamic content management services, delivery services, payment services, notification services, and product coordination services. Application servers 130 may include an account server 132, a buying server 134, a selling server 136, a listing catalog server 138, a dynamic content management server 140, a payment server 142, a notification server 144, and/or a delivery server 146 structured and arranged to provide product coordination services.

Application servers 130, in turn, may be coupled to and capable of accessing one or more databases 150 including a subscriber database 152, an active events database 154, and/or a transaction database 156. Databases 150 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments.

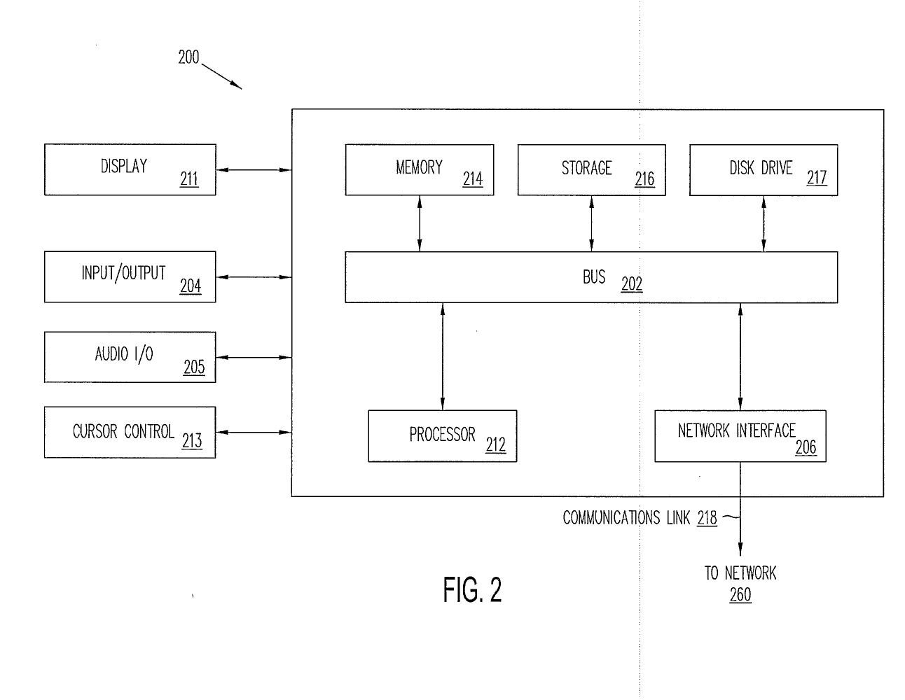

Continuing with FIG. 2, an exemplary computer system 200 suitable for implementing on one or more devices of the computing system in FIG. 1 is depicted in block diagram format. In various implementations, a device that includes computer system 200 may comprise a personal computing device (e.g., a smart phone, a computing tablet, a personal computer, laptop, PDA, Bluetooth device, key FOB, badge, etc.) that is capable of communicating with a network. The merchant and/or a payment provider may utilize a network computing device (e.g., a network server) capable of communicating with the network. It should be appreciated that each of the devices utilized by users, merchants, and payment providers may be implemented as computer system 200 in a manner as follows.

Computer system 200 can include a bus 202 or other communication mechanism for communicating information data, signals, and information between various components of computer system 200. Components include an input/output (I/O) component 204 that processes a user action, such as selecting keys from a keypad/keyboard, selecting one or more buttons or links, etc., and sends a corresponding signal to bus 202. I/O component 204 may also include an output component, such as a display 211 and a cursor control 213 (such as a keyboard, keypad, mouse, etc.). An optional audio input/output component 205 may also be included to allow a user to use voice for inputting information by converting audio signals. Audio I/O component 205 may allow the user to hear audio. A transceiver or network interface 206 transmits and receives signals between computer system 200 and other devices, such as another user device, a merchant server, or a payment provider server via a network. In an embodiment, the transmission is wireless, although other transmission mediums and methods may also be suitable. A processor 212, which can be a micro-controller, digital signal processor (DSP), or other processing component, processes these various signals, such as for display on computer system 200 or transmission to other devices over a network 260 via a communication link 218. Processor 212 may also control transmission of information, such as cookies or IP addresses, to other devices.

Components of computer system 200 also include a system memory component 214 (e.g., RAM), a static storage component 216 (e.g., ROM), and/or a disk drive 217. Computer system 200 performs specific operations by processor 212 and other components by executing one or more sequences of instructions contained in system memory component 214. Logic may be encoded in a computer readable medium, which may refer to any medium that participates in providing instructions to processor 212 for execution. Such a medium may take many forms, including but not limited to, non-volatile media, volatile media, and transmission media. In various implementations, non-volatile media includes optical or magnetic disks, volatile media includes dynamic memory, such as system memory component 214, and transmission media includes coaxial cables, copper wire, and fiber optics, including wires that comprise bus 202. In an embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments, execution of instruction sequences for practicing the embodiments may be performed by a computer system. In various other embodiments, a plurality of computer systems coupled by a communication link (e.g., LAN, WLAN, PTSN, or various other wired or wireless networks) may perform instruction sequences to practice the embodiments in coordination with one another. Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

### Coordinated Purchases

As will be readily appreciated, the foregoing networks, systems, devices, and numerous variations thereof can be used to implement various embodiments of the coordinated purchasing system. The coordinated purchasing system can be provided by a service provider, such as, for example, eBay Inc. of San Jose, Calif. The coordinated purchasing system can be provided by an online merchant, a payment provider, a dedicated coordination system, or any other system or entity.

In various embodiments, one or more systems and methods that facilitate or provide coordinated purchase are provided. Various embodiments are discussed herein. Various other details and features may also be included, as will be appreciated.

As noted with respect to FIG. 2 above, a computer system 200 can include one or more processors 212 and one or more memories or storage devices 214, 216. Such a computer system 200 can be part of a user device, part of one or more servers on a network-bases system, or some combination thereof. In particular, a given computing system can include a first memory device or storage component adapted to store information regarding one or more users of the system, as well as a second memory device or storage component adapted to store information regarding product relationships and product coordination. The relationship information can include information regarding a plurality of products and their relationships to other products, such as which products require other products for operation thereof and which such other products are required. In some embodiments, a single memory device or storage component can be used to store information regarding users as well as product relationships, purchase histories, shipping information, and the like.

In addition, one or more processors 212 can be adapted to facilitate the determination of product relationships and/or can be adapted to facilitate the providing of product coordination. Further functionality of the one or more processors 212 can include facilitating communication, merchant transaction, information mining (such as for product relationships.

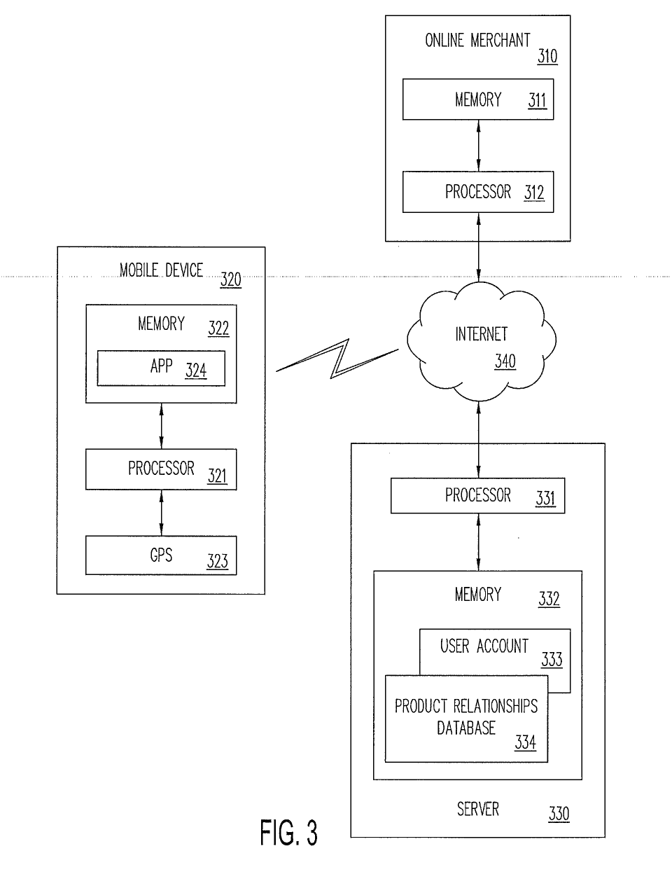

FIG. 3 is a block diagram of a system for facilitating coordinated purchases, according to an embodiment. The system can include a merchant device 310, a mobile device 320, and/or a server 330, for example. The functions and components discussed herein can be split and/or shared among the merchant device 310, the mobile device 320, the server 330, and/or any other devices or systems, as desired.

The merchant device 310 can comprise a merchant checkout terminal, a computer, and/or a server, for example. The merchant device 310 can comprise a server for facilitating online sales. The merchant device 310 can include a memory 311 and a processor 312. The merchant device 310 can be used for processing purchases from the merchant.

The merchant device 310 can be used for facilitated coordinated purchasing, as described herein. For example, the processor 312 can be used for determining product relationships and for facilitating product coordination. As a further example, the memory 311 can contain a user account and/or a product relationship database.

The merchant device 310 can be used for processing sales, determining product relationships, and/or facilitating product coordination either online or from a brick and mortar location. The coordinated purchase system described herein can be practiced online, at a brick and mortar store, or in any combination thereof.

The mobile device 320 can be carried by the user. The mobile device 320 can comprise a cellular telephone, a smart telephone, a hand held computer, a laptop computer, a notebook computer, or a tablet computer, for example. The mobile device 320 can include a processor 321, a memory 322, and a global positioning system (GPS) 323.

The mobile device 320 can be used for routine telephone calls, text messaging, web browsing, and the like. The mobile device 320 can be used for purchasing products by the user and for practicing the method for coordinating products, as discussed herein.

The mobile device 320 can be used for facilitated coordinated purchasing, as described herein. For example, the processor 321 can be used for determining product relationships and for facilitating product coordination. As a further example, the memory 332 can contain a user account and/or a product relationship database.

An app 324 can be stored in the memory 322 and executed by the processor 321. The app 324 can be used for purchasing products by the user and for practicing the method for coordinating products, as discussed herein.

The server 330 can comprise a server of a payment provider, such as Paypal, Inc. The server 330 can be a server of a merchant or any other entity. The server 330 can be a dedicated coordinated purchase server. The server 330 can be a single server or can be a plurality of servers. The server 330 can include one or more processors 331 and one or more memories 332. The memory 332 can be a memory of the server 330 or a memory that is associated with the server 330. The memory 332 can be a distributed memory. The memory 332 can store a user account 333 and a product relationship database 334, for example.

The server 330 can be used for practicing the coordinated purchase method, as disclosed herein. For example, the processor 331 can be used for determining product relationships and for facilitating product coordination. As a further example, the memory 332 can contain a user account and/or a product relationship database. The server 330 can be used for any other desired purpose or combination of purposes.

Generally, the merchant device 310, the mobile device 320, and the server 330 can perform functions discussed herein. That is, at least to some extent, a function that is discussed herein as being performed via a particular one of these devices can be performed by a different one of these devices, by a combination of these devices, and/or by other devices

The merchant device 310, the mobile device 320, and the server 330 can communicate with one another via a network, such as the Internet 340. The merchant device 310, the mobile device 320, and the server 330 can communicate with one another via one or more networks, such as local area networks (LANs), wide area networks (WANs), cellular telephone networks, and the like. The merchant device 310, the mobile device 320, and the server 330 can communicate with one another, at least partially, via one or more near field communications (NFC) methods or other short range communications methods, such as infrared (IR), Bluetooth, WiFi, and WiMax.

### Methods

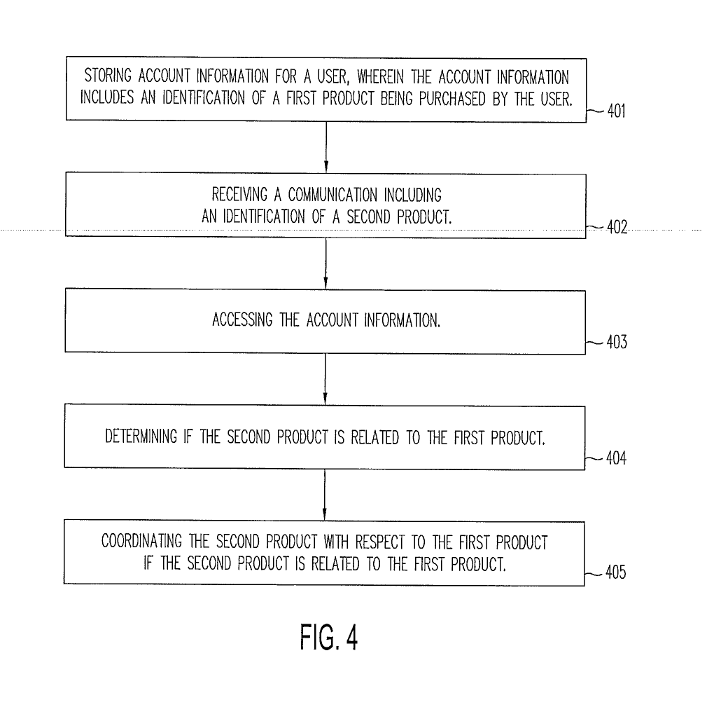

FIG. 4 is a flow chart showing operation of the coordinated purchase system, according to an embodiment. Note that one or more of the steps described herein may be combined, omitted, or performed in a different order, as desired or appropriate.

Account information for a user can be stored, as shown in step 401. The account information can include an identification of a first product, such as a product being purchased by and/or shipped to the user. The first product can be a product that the user is purchasing or has expressed an interest in purchasing. The first product can be a product that is in a shopping cart, such as an online shopping cart, of the user and can be a product for which the purchase has not yet been finalized. The first product can be a product for which the purchase has been finalized. The first product can be a product which has shipped. Thus, first product can be unpurchased, purchased, unshipped, or shipped. The account information can be stored in one or more memories, such as the memory 332 of the server 330.

The first product can have been purchased and/or shipped recently or a substantial time ago. The first product can have been purchased and/or shipped at any time.

A communication can be received, as shown in step 402. The communication can include an identification of a second product. The second product can be a product to be purchase by and/or shipped to the user. For example, the second product can be a product that the user is purchasing or has expressed an interest in purchasing. The second product can be a product that is in a shopping cart of the user and can be a product for which the purchase has not yet been finalized. Thus, the second product can be unpurchased, purchased, or unshipped.

The communication can be received via one or more hardware processors in communication with the one or more memories. For example, the communication can be sent by the user via the mobile device 320 and can be received via the processor 331 of the server 330. The communication can be from the user, from another person, from a device, or from anything else. The communication can be within a device or system practicing the method or a portion of the method discussed herein. The communication can be any communication that identifies the second product.

The account information can be accessed, as shown in step 403. The account information can be accessed via the one or more hardware processors, such as processor 331. The account information can be accessed from the user account 333 stored in the memory 332.

Whether or not the second product is related to the first product can be determined, as shown in step 404. Whether or not the second product is related to the first product can be determined via the one or more hardware processors, such as processor 331. For example, when the second product is purchased or when the user expressed an interest in purchasing the second product, then the product relationship database 334 can be queried by the processor 331 to determine if there is an entry for either the first product or the second product. If there is an entry for one of the two products, then the product relationship database 334 can be used to determine if the other of the two products are compatible with one another.

For example, if there is an entry in the product relationship database 334 for a particular flashlight, then the appropriate batteries for the flashlight can be provided in the product relationship database 334. That is, the appropriate batteries can be associated with the flashlight in the product relationship database 334. When the flashlight is purchased, then the appropriate batteries for the flashlight can be checked against batteries that are also being purchased to verify that the batteries are appropriate for the flashlight. If the batteries are not appropriate for the flashlight, the user can be notified and/or appropriate batteries can be substituted in the order.

Such substitutions that cost more than the original product can require authorization of the user. Substitutions that cost more than the original product by a predetermined amount can require authorization of the user. For example, the user can pre-authorize substitutions up to a fixed dollar amount ($5.00, for example) or up to a percentage of the first product price (5%, for example).

If the product is not found in the product relationship database 334, then the Internet, merchant information or databases, or any other source can be consulted to determine product relationships and/or compatibility. Various machines, devices, databases, servers, people, and the like can be consulted to determine product relationships and/or compatibility.

Relationships and/or compatibility can be inferred from sales histories, such as a sales history of the user, for example. Thus, if the user has purchased particular batteries in the past and then orders different batteries in the present, then the user can be notified of the discrepancy.

The second product can be coordinated with respect to the first product, as shown in step 405. The second product can be coordinated with respect to the first product, if the second product is related to the first product. The second product can be coordinated with respect to the first product via one or more hardware processors 331.

Coordinating the second product can comprise verifying compatibility of the second product with respect to the first product. For example, if the second product is a set of batteries for the first product, then coordinating the purchase of the second product can comprise verifying that the batteries are suitable for use in the first product.

Coordinating the second product can comprise arranging delivery of the second product at a time that is suitable with respect to the first product. If the second product is a set of batteries for the first product, the delivery of the second product can be arranged to generally coincide with delivery of the first product.

Determining if the second product is related to the first product, as shown in step 404, and/or coordinating the second product with respect to the first product, as shown in step 405, can be performed automatically, such as in response to the user purchasing or indicating an interest in purchasing the second product. Alternatively, determining if the second product is related to the first product, as shown in step 404, and/or coordinating the second product with respect to the first product, as shown in step 405, can be performed in response to a user request. For example, the user can request that such determining and coordination be performed by selecting a button or icon during the purchase procedure for the second product.

If second product is determined to be incompatible with the first product, then a different second product can be suggested or purchased for the user. If the first product has already been purchased, but has not yet shipped, and the second product is determined to be incompatible with the first product, then a different first product can be suggested or purchased for the user and the purchase of the first product can be cancelled.

The one or more memories and/or the one or more processors can be one or more memories and/or the one or more processors of the merchant device, 310, the user device 320, the server 330, and/or any other device or system. Memories and/or processors from any number of devices, systems, and entities can cooperate to perform the coordinated product method disclosed herein.

According to an embodiment, social networking information can provide or imply a product relationship. For example, if social network information tends to indicate that when one product is purchase, another product tends to be purchase as well, then a product relationship can be implied between the two products. For example, if social network information indicates that when airline tickets to Aspen are purchase, thermal underwear is also purchased, then a relationship between airline tickets to Aspen and thermal underwear can be inferred by the system.

Social networking information can include likes, interests, past events, wants, owns and so forth, such as may be found on social networking websites such as Facebook, YouTube, Twitter, LinkedIn, Yelp, MeetMe, MyYearbook, Google+, MySpace, Pinterest, and the like, among other possible websites. External information can include song or artist lists on a separate user device or profile, as well as data from media websites or applications, such as Pandora, Spotify, iTunes, and the like.

Product relationships can be inferred from various different sources. For example, product relationships can be inferred from merchant advertisements, such as via the Internet.

Once two or more products are identified as being related and should arrive on the same date or some specific relative data relationship with other products, the system may determine when each of the products should ship from their respective merchants. A desired arrival date may first be determined for each product and then the ship date backed out from the arrival date, based on shipping method, product location, expected weather conditions from the product location to the product destination, high volume shipping periods, etc. For example, it may be valuable to the user to pay a little extra to have expedited shipping for a product farther away or taking more time to ship (such as waiting for arrival) and regular shipping on one or more other related products. Thus, shipping dates and/or methods may be conveyed to merchants to coordinate desired arrival date(s) of purchased products.

In implementation, at least some of the various embodiments may comprise a personal computing device, such as a personal computer, laptop, PDA, cellular phone or other personal computing or communication devices. Coordinated purchasing may be implemented by a payment provider system, such as that of PayPal. The payment provider system may comprise a network computing device, such as a server or a plurality of servers, computers, or processors, combined to define a computer system or network to provide payment services and coordinated purchasing.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In an embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the embodiments.

Payment processing can be through known methods, such as transaction details being communicated to the payment provider through the app, the payment provider processing the details, which may include user account and identifier information and authentication, merchant information, and transaction details. The user account may be accessed to determine if any restrictions or limitations may prevent the transaction from being approved. If approved, the payment provider may send a notification to the merchant and/or the user. Payment can be via cash, a credit card, a debit card, a gift card, or any other means.

As used herein, the term “related” can be used to characterize associations wherein one product is used within or along with another product. As used herein, the term “related” can be used to characterize associations wherein one product is required in order to use another product. As used herein, the term “related” can be used to characterize associations between products wherein a user finds it useful, beneficial, or desirable to have one product when the user has another product.

As used herein, the term “coordinated” can include an aspect of receiving, having, owning, using, or otherwise benefiting from two or more products. For example, two or more products can be coordinated when a synergistic effect is realized from having both products.

As used herein, the term “store” can include any business or place of business. The store can be a brick and mortar store or an online store. Examples of stores can include supermarkets, discount stores, book stores, convenience stores, restaurants, gas stations, auto repair shops, and movie theaters. The store can be any person or entity that sells a product and/or provides a service.

As used herein, the term “product” can include any item or service. Thus, the term “product” can refer to physical products, digital goods, services, or anything for which a user can make a payment, including charitable donations. A product can be anything that can be sold. Examples of products include cellular telephones, concerts, meals, hotel rooms, automotive repair, haircuts, digital music, and books. The product can be a single item or a plurality of items. For example, the product can be a tube of toothpaste, a box of laundry detergent, three shirts, and a donut.

As used herein, the term “merchant” can include any seller of products. The term merchant can include a store. The products can be sold from a store or in any other manner.

As used herein, the term “mobile device” can include any portable electronic device that can facilitate data communications, such as via a cellular network and/or the Internet. Examples of mobile devices include cellular telephones, smart phones, tablet computers, and laptop computers.

As used herein, the term “network” can include one or more local area networks (LANs) such as business networks, one or more wide area networks (WANs) such as the Internet, one or more cellular telephone networks, or any other type or combination of electronic or optical networks.

As used herein, the term “card” can refer to any card or other device that can be used to make a purchase in place of cash. For example, the card can be a bank card, credit card, debit card, gift card, or other device. The card can be a token, such as a hardware token or a software token. The card can be stored in and/or displayed upon a user device, such as a cellular telephone.

Thus, according to one or more embodiments, products can ship together (or at approximately the same time), work together, and otherwise be compatible. By reducing concerns about delivery time and compatibility, the shopping experience can be enhanced. Coordination of products can add value to a purchase that can be as worthwhile as a cost savings, e.g., product discount. Such value can often be added with little or no cost to the merchant or merchants providing the value.

The foregoing disclosure is not intended to limit the disclosure to the precise forms or particular fields of use disclosed. It is contemplated that various alternate embodiments and/or modifications, whether explicitly described or implied herein, are possible in light of the disclosure. Having thus described various example embodiments of the disclosure, persons of ordinary skill in the art will recognize that changes may be made in form and detail without departing from the scope of the disclosure. Thus, the disclosure is limited only by the claims.

What is claimed is:

1. A system comprising:
one or more memories storing account information for a user, the account information including an identification of a first product being purchased by the user;
one or more hardware processors in communication with the one or more memories and operable to:
receive a communication including an identification of a second product;
access the account information to identify the first product;
determine that the second product is related to the first product; and
coordinate shipping of the second product with respect to the first product.

2. The system of claim 1, wherein the second product is related to the first product if the first product and the second product are used together.

3. The system of claim 1, wherein the second product is related to the first product if the second product is commonly purchased along with the first product.

4. The system of claim 1, wherein coordinating the shipping comprises shipping the second product such that the second product arrives within substantially a predetermined amount of time with respect to arrival of the first product.

5. The system of claim 1, wherein the identification of the second product is provided by the user and further comprising sending a communication to the user that the second product is not compatible respect to with the first product, wherein the communication regards compatibility of the second product with respect to the first product.

6. The system of claim 1, wherein the one or more hardware processors are further operable to send a communication to the user if the second product is not compatible with respect to the first product and wherein the communication suggests an alternative to the second product that is compatible with respect to the first product.

7. The system of claim 1, wherein the one or more hardware processors are further operable to send a communication to the user and wherein the communication suggests an additional product that is compatible with respect to the first product and the second product.

8. The system of claim 1, wherein a seller of the first product is unrelated to a seller of the second product.

9. The system of claim 1, wherein the second product is suggested to the user by the system.

10. The system of claim 1, wherein determining if the second product is related to first product comprises accessing a database of product relationships.

11. A method comprising:
receiving, via one or more hardware processors in communication with one or more memories, a communication including an identification of a first product;
accessing, via the one or more hardware processors, account information for a user to identify a second product being purchased by the user;
determining, via the one or more hardware processors, that the first product is related to the second product; and
coordinating, the via one or more hardware processors, shipping of the first product with respect to the second product.

12. The method of claim 11, wherein the first product is related to the second product if the first product and the second product are used together.

13. The method of claim 11, wherein the first product is related to the second product if the first product is commonly purchased along with the second product.

14. The method of claim 11, wherein coordinating the shipping comprises shipping the first product such that the first product arrives within substantially a predetermined amount of time with respect to arrival of the second product.

15. The method of claim 11, wherein identification of the first product is provided by the user and further comprising sending a communication to the user that the first product is not compatible respect to with the second product, wherein the communication regards compatibility of the first product with respect to the second product.

16. The method of claim 11, further comprising sending a communication to the user if the first product is not compatible with respect to the second product and wherein the communication suggests an alternative to the first product that is compatible with respect to the second product.

17. The method of claim 11, further comprising sending a communication to the user and wherein the communication suggests an additional product that is compatible with respect to the first product and the second product.

18. The method of claim 11, wherein a seller of the first product is unrelated to a seller of the second product.

19. The method of claim 11, wherein the first product is suggested to the user by the system.

20. The method of claim 11, wherein determining if the second product is second to first product comprises accessing a database of product relationships.

21. A computer program product comprising a non-transitory computer readable medium having computer readable and executable code for instructing one or more processors to perform a method, the method comprising:
receiving a communication including an identification of a first product;
accessing account information of a user to identify a second product being purchased by the user;
determining that the first product is related to the second product; and
coordinating shipping of the first product with respect to the second.
